(19) United States
(12) Patent Application Publication
(10) Pub. No.: US 2006/0098772 A1
(43) Pub. Date: May 11, 2006

(54) Distance meter

(75) Inventors: Akseli Reho, Kankaanpaa (FI); Tapio Karinsalo, Kankaapaa (FI)

Correspondence Address: YOUNG & THOMPSON, 745 SOUTH 23RD STREET, 2ND FLOOR, ARLINGTON, VA, 22202, US

(73) Assignee: CLOTHING PLUS OY, KANKAANPAA (FI)

(21) Appl. No.: 10/532,874

(22) PCT Filed: Oct. 27, 2003
(86) PCT No.: PCT/FI03/00798

§ 371 Date: Apr. 28, 2005

(30) Foreign Application Priority Data
Oct. 28, 2002 (FI) 20021913

(51) Int. Cl. A63B 71/00; G01C 21/00

(52) U.S. Cl. 377/24.2; 482/8

(57) ABSTRACT

The invention relates to a method (800), a sytem (100) and a device (102) for measuring the number of laps and/or the distance covered by a person during his/her performance. The invention relates particularly to a distance meter (102) to be worn by the user, which measures the distance covered by the object and comprises a magnetic sensor (212) for determining the direction of a magnetic field (304) external to the sensor relative to the sensor (212). The distance meter (102) to be worn by the user in accordance with the invention also comprises a counter (207), whose value is increased when the measured deviation of the magnetic field exceeds a preset limit, i.e. in the situation where a fitness trainer following a given track turns and starts moving into another direction on the track.

The invention relates to a distance meter. The invention relates specifically to a lap and distance counter for fitness trainers such as swimmers.

During their exercise, fitness trainers often move back and forth along a given path, with the exercise target typically set as a covered distance or number of laps. Fitness swimmers, for instance, typically carry out complete, successively repeated laps on a 25 or 50 m track in a swimming bath, sprinters run over a predetermined distance of a given stretch and skaters or runners carry out several laps along an oval track. Typical training comprises counting the covered distance or number of laps.

One manner of evaluating the performance and metering the distance is counting the number of laps and multiplying the obtained number with the length of the lap. Under exercising conditions, for instance, a fitness trainer will have to count the number of laps personally. This involves the problem that, while covering long distances or carrying out several laps, the trainer has difficulties in finally remembering the number of laps performed, especially if he/she has to concentrate on improving e.g. a special technique at the same time, or if the performance has lasted a long time and the trainer is getting tired. In addition, especially in public swimming baths, there are many other persons exercising and other disturbing factors, which tend to affect the trainer's concentration and counting of laps.

One solution to the problems mentioned above is provided by an abacus, for instance, in which the trainer shifts one bead for each performed lap. There are also known solutions, in which the fitness trainer carries a transceiver means, such as the ultrasonic solution disclosed by U.S. Pat. No. 5,136,621, in which the performance of one lap is registered as the fitness trainer carrying the device passes by a certain control station. There are also various prior art solutions based on GPS means and acceleration sensors, which monitor the trainer's movements in order to conclude the speed and the covered distance. U.S. Pat. No. 5,767,417 discloses a solution specially conceived for swimmers with a view to measuring the covered distance and speed, comprising means attached to the swimmer's body for measuring the water current. In addition, there is a prior art solution especially for swimmers, in which the swimmer hits a detector provided at the end of the pool, with his hand, for instance, in order to mark a lap and thus to determine the covered distance.

However, solutions of the kind above involve problems. Using an abacus, for instance, or touching a detector provided at the end of the track, such as a pool, requires free access for the swimmer all the way to the abacus or the detector, and his/her paying special attention to marking the performed lap. What is more, for fitness swimmers, who make an orthodox U-turn at the end of the pool, it is even impossible to use an abacus or a detector to be touched. A further reason is that, on public premises, there may be mischief, involving intentional changes of the counted number of laps during the use of an abacus or a detector to be touched. In addition, special transceiver means should be fitted in position during the exercise, and this may be an impossible task in a public skating rink or swimming bath, which is full of people exercising. Also, solutions based on GPS means and acceleration sensors are costly and often inaccurate as well. Thus, for instance, with a fitness trainer exercising at an indoor gym, there may be problems in communicating between a GPS means and the satellite. Furthermore, the solution based on measurement of the water current as disclosed by U.S. Pat. No. 5,767,417 is suitable only for swimmers, and it should also be noted that such a device, when used on public premises, might be anaesthetic and even interfere with many a fitness trainer's performances.

The purpose of the present invention is to provide an economical system for measuring the distance covered by a fitness trainer, which is easy to use and does not disturb him/her, allowing the prior art shortcomings mentioned above to be reduced. The invention aims at bringing a solution to the special issue of how to count the number of laps repeatedly carried out by an object moving around a given track and how to measure the distance covered without the trainer having to concentrate on counting the number of laps or on using a device. Another purpose of the invention is to conceive a solution allowing the number of performed laps or the covered distance to be readily displayed to the training person during and/or after the performance.

The goals of the invention are achieved as follows: the distance meter of the invention, which comprises means for measuring the direction of an external magnetic field, is worn by the person, and one lap or track side is marked as covered when a deviation of the magnetic sensor of the distance meter relative to the direction of the external magnetic field measured by the sensor exceeds a set limit value, i.e. a situation where the person turns into another direction of movement on the track. The distance meter determines the covered distance with the aid of the number of laps/length of sides it has counted and the fed length of one single lap/side. In addition, the goals of the invention are achieved by bringing the distance meter in data transmission communication with at least one other data processing device, such as, for instance, a device for measuring pulse data, and by storing the number of performed laps as a function of time.

The method of the invention for measuring the distance covered by a person is characterised by
fastening on the person a magnetic sensor having substantially stationary direction relative to the person,
monitoring any deviation of the magnetic sensor from a magnetic field external to the sensor, and
counting the times the deviation of the magnetic sensor from the external magnetic field exceeds a set limit value.

The distance meter of the invention for measuring the distance covered by an object is characterised by the distance meter being worn by the person and comprising a magnetic sensor for determining the direction of the magnetic sensor relative to a magnetic field external to the sensor, and also a counter and the distance meter to be worn by the user being arranged to increase the meter value when the deviation of the magnetic sensor from the external magnetic field exceeds a set limit value.

A number of preferred embodiments of the invention are defined in the dependent claims.

This patent application uses the following concepts, among other things:
In this application “a lap” denotes typically either a complete lap, which is completed when the training person returns to his/her starting point after having performed a complete lap or half a lap around the track, such as, for instance, the length of one stretch of a swimming pool. It should be noted that a complete lap may be e.g. triangular, and then a lap may imply the entire lap or one third of the entire lap, i.e. one side length, or in the case of a square or oval track, a lap may stand for the entire lap or one fourth of the lap, i.e. one side length. It is obvious to those skilled in the art that various combinations expressing the type of track can be implemented.
“A person” or object may be a fitness trainer, for instance, such as a swimmer, a sprinter, a runner, a skater, a ski jumper, a downhill racer, a canoeist or any other object, human or other animal being, who moves along a track with his/her direction of movement regularly reversed, such as e.g. a runner running along an oval running track, or a swimmer swimming back and forth along a swimming track in a swimming pool.
“Type of sport” or mode of use is the data describing the sport to be performed which is fed into the distance meter to be worn by the user, such as swimming, running or skating. With e.g. swimming fed as type of sport into the distance meter, the distance meter will be in “the swimming mode”, being especially arranged to evaluate the results it has measured compared to the determined type of sport.
“Magnetic field” is a magnetic field that is generated by a source external to the distance meter and that can be measured by the magnetic sensor of the distance meter, such as the magnetic field of the earth. The magnetic field can also be artificially generated by means of an electromagnet, for instance.

The invention achieves considerable advantages over prior art solutions. The distance meter to be worn by the user in accordance with the invention can be used without an external counter-means for accurate counting of laps. The invention also allows for a lightweight and very small-sized meter, having a size even smaller than that of a matchbox, so that the meter does not interfere with the fitness trainer's performances and also is acceptable from a social point of view. The distance meter of the invention can also be made such that it can be fastened to the person's garments by means of a simple fastening mechanism, allowing the distance meter to be used with several garments and in different sports, and it is also easy to detach for laundry, change of garment or purchase of a new garment, for instance.

The fastening mechanism may be carried out by means of e.g. a press-stud, a Velcro tape or a suspender, allowing the distance meter to be fastened directly to the garment, such as a belt, a pair of trousers, a pair of trunks or a headgear. The meter can also be equipped with a separate belt or strap for fastening the meter. The fitness trainer's garment, such as a pair of trunks, may also have a pocket specifically designed for the distance meter, and the pocket can be transparent, allowing the fitness trainer to check his/her performance on the screen of a distance meter equipped with a display, directly through the garment, without detaching the meter. With the pocket on the garment designed for the meter, it is ensured that the meter is maintained in position during the performance. The most reliable point for fastening in terms of measurement techniques and the most advantageous point is fastening to the carrier's trousers, especially in the hip area, because the person's pelvic area remains stable compared to his hands or feet, for instance, during running, skating and swimming.

The invention has the special advantage of the magnetic sensor provided in the distance meter, allowing measurements of the direction of a magnetic field external to the meter, such as the magnetic field of the earth, relative to the meter. The magnetic sensor is preferably a biaxial magnetic sensor, but it can optionally be a triaxial magnetic sensor. In addition, the distance meter can be equipped with control means, such as press-studs, by means of which the meter can be switched on and which can be used for feeding in advance the length of a lap or a side into the meter.

In one embodiment, the type of the track to be performed can also be fed into the meter, such as e.g. an oval shape or a straight back and forth track, such as the track of a swimming pool, and the type of sport, such as e.g. swimming, running or skating. The type of the track to be performed can also be triangular, circular or have any other distinct geometric pattern that can be illustrated in a plane. According to a further embodiment of the invention, a limit value for a deviation of the magnetic sensor relative to the external magnetic field can be fed and set in the distance meter. Optionally, the user can conclude the limit value by means of the fed track geometry without requiring actions.

In one embodiment, the distance meter of the invention can be arranged in data transmission communication with another device, such as, for instance, a pulse meter, and then the distance mater can deliver data it has measured, such as the number of laps or the distance covered, to the pulse meter in the course of the sports performance. This allows the fitness trainer to check the number of laps and/or the distance covered on a pulse meter at his/her wrist. In addition, decoding of the pulse meter data may provide the pulse as a function of time and also as a function of the covered distance. Optionally, the data collected by the distance meter can be delivered also to other data processing devices, such as a display panel or a computer, for subsequent analysis, among other purposes. The distance meter preferably comprises also a memory unit, allowing delivery of data only after the sports performance has ended.

The data transmission communication can be performed e.g. with a short-range radio link, such as Bluetooth technology, or by optical means, such as e.g. by means of an IR transceiver. The data transmission communication can be performed also by means of any other data transmission method known by those skilled in the art, such as e.g. wire data transmission technology.

The distance meter of the invention can also be equipped with a screen for displaying e.g. the number of counted laps and/or the covered distance and also for displaying fed data, instructions and other data, such as user interface data. The display is preferably an LCD display, but it may also be any other display known by those skilled in the art.

In one embodiment, the distance meter can be equipped also with means for detecting the meter mode, so that the meter detects when it is being carried by a user, the meter passing accordingly into standby state, for instance, without requiring the user to take actions when fastening the meter to his/her garments. The means for detecting standby may be e.g. a capacitive sensor for measuring the permittivity of the environment, or a sensor measuring the temperature, the electric conductivity or the moisture. While the user is fastening the meter to his/her garment, any of these variables may change under the effect of the user's presence, so that the meter may conclude that it is being carried and pass into standby, and then measurements can be activated for example by pressing the meter or any press button on the meter. In addition, a distance meter especially devised for swimmers can be equipped with a moisture sensor allowing detection of the swimmer being in the water, and then the measurement unit is activated.

In a further embodiment, the distance meter of the invention can be equipped with a sensor detecting the fitness trainer's position. The sensor detecting the position may be a separate sensor detecting the position, or optionally a magnetic sensor with several axes. A distance meter especially intended for swimmers or a distance meter in swimming mode may detect when the swimmer is in swimming position and when he/she is in vertical position. This allows erroneous counting of the laps due to vertical rotation at the pool end to be avoided. Also, a sensor detecting the position may detect whether the swimmer is doing backstroke or swimming on his/her stomach, thus preventing registering of false information in situations where the swimmer switches from butterfly to backstroke in the course of a lap.

The distance meter can also be equipped with a controller “learning” the lap cycle, comprising several modes for each sport and also allowing for the geometric type and length of the fed lap and capable of evaluating the reliability of the performance compared to any fed sport and track data. Thus, for instance, if the user has fed swimming as the type of sport and 100 metres as the length of a track lap, it is unlikely that one lap would be performed in less than 20 seconds; yet this is feasible in skating on a 100 m. track. In one embodiment, the controller can monitor the lap times performed by the trainer in different sports and infer the reliability of the marked lap from this. The controller may thus reject the marking of a lap, or at least give the trainer a warning of this, in case the lap time seems impracticable. One of the reasons for this may be a wrong definition of the sport, of the length of the lap/side or the geometric pattern of the lap, or optionally it may be due to the fact that the distance meter has been kept switched on at other times than during the sports performance, tending to cause “unnecessary” rotation.

In one embodiment, the controller may “average” the direction of the measured magnetic field, and then any momentary deviation caused e.g. by a rotation or the detour of an obstacle in the course of the lap can be ignored in the counting of the laps. In another embodiment of the invention, the sampling frequency can also be changed depending on the distance, the sport and/or the track. In long-distance swimming mode, for instance, and on a long track side, the direction of the magnetic field can be measured by using a longer interval (a smaller sampling frequency) than in the case of a fast sport and/or a short track.

Also, the distance meter to be worn by the user in accordance with the invention can be programmed before the sports performance starts to give an alarm when the preset number of laps or distance is covered. If, for instance, a swimmer wishes to swim 1,000 metres in a 25 m pool, he can program the distance meter to give an alarm when 1,000 metres, 20 laps or 40 side lengths are covered. The distance metre of the invention may give an alarm by means of an acoustic signal, a light signal or a vibration, for instance. Optionally the programming and/or alarm can be performed together with another data processing device compatible with the distance meter to be worn by the user in accordance with the invention, such as a pulse meter, for instance.

The distance meter can be programmed with an electric identifier (ID) identifying the distance meter or the fitness trainer, and in that case, if a plurality of distance meters are at a close mutual distance, it can be avoided that the data of different distance meters get mixed with each other as data are transferred by means of other data processing devices, for instance.

In its most straightforward embodiment, the distance meter of the invention is set into measuring mode at the beginning of the performance, and the measurement is terminated at the end of the performance using a control button on the meter.

Preferred embodiments of the invention are explained in further detail below with reference to the accompanying drawings, in which

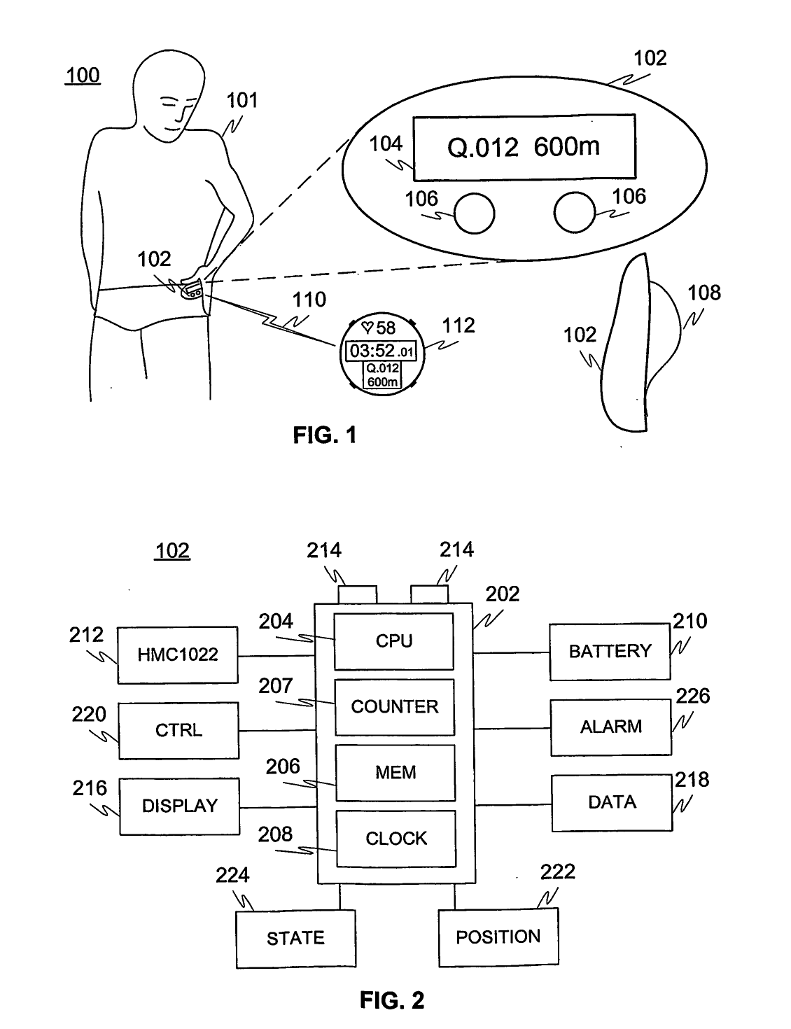

FIG. 1 shows an exemplified distance meter to be worn by the user and a system for providing data transmission communication between the distance meter to be worn by the user and a data processing device in accordance with one embodiment of the invention,

FIG. 2 shows a block diagram of an exemplified distance meter to be worn by the user in accordance with one embodiment of the present invention,

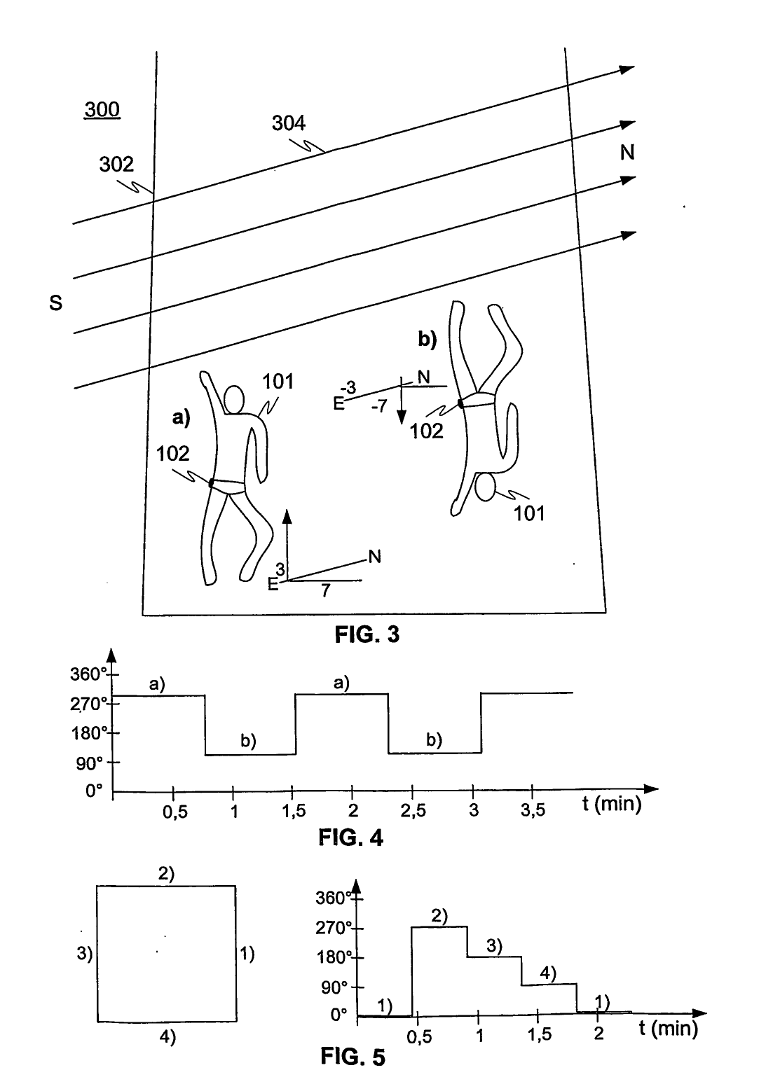

FIG. 3 shows the operating mode of an exemplified distance meter to be worn by the user in accordance with one embodiment of the invention,

FIG. 4 shows the direction of a magnetic field measured by the distance meter of the invention as a function of time in a swimming pool of FIG. 3, with movement in accordance with one embodiment of the present invention,

FIG. 5 shows the direction of a magnetic field measured by the distance meter of the invention as a function of time, while a fitness trailer equipped with the distance meter is moving along a square track in accordance with one embodiment of the present invention,

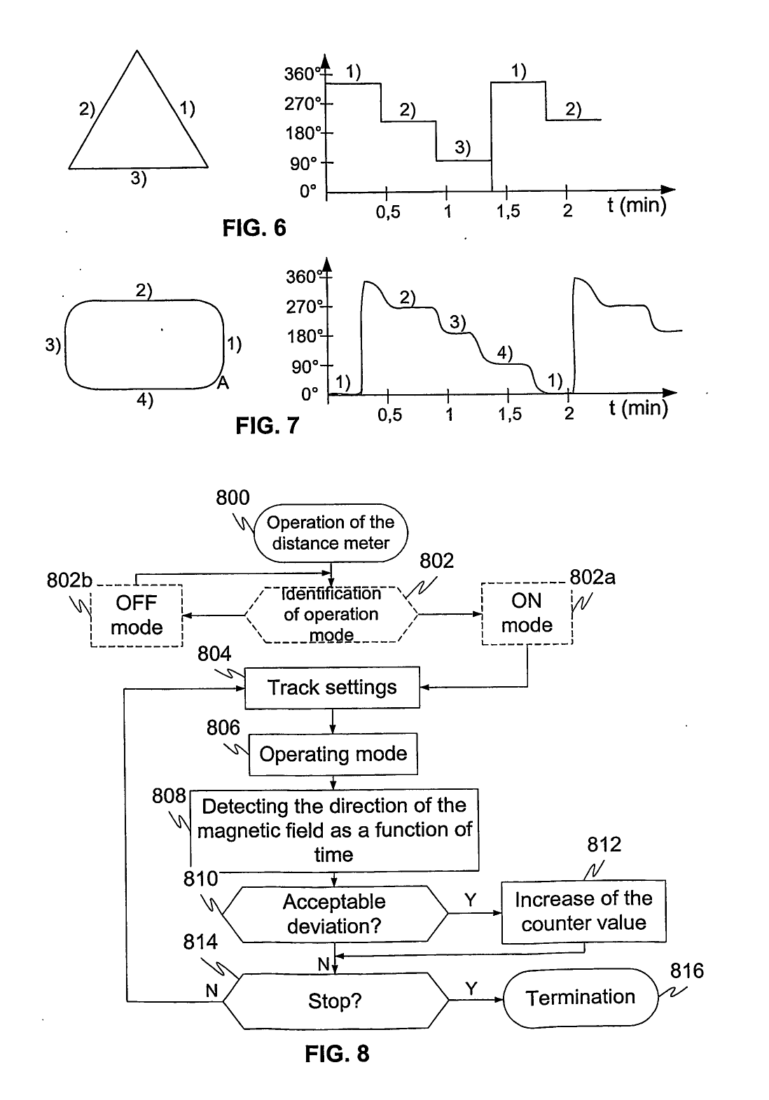

FIG. 6 shows the direction of a magnetic field measured by the distance meter of the invention as a function of time, while a fitness trailer equipped with the distance meter is moving along a triangular track in accordance with one embodiment of the present invention,

FIG. 7 shows the direction of a magnetic field measured by the distance meter of the invention as a function of time, while a fitness trailer equipped with the distance meter is moving along an oval track in accordance with one embodiment of the present invention,

FIG. 8 shows an exemplified method for enabling the operation of the distance meter in accordance with one embodiment of the present invention.

FIG. 1 illustrates an exemplified distance meter 102 of the present invention to be worn by a person 101 and also a system 100 for providing data transmission communication 110 between the distance meter 102 and a data processing device 112 in accordance with one embodiment of the present invention. The distance meter is typically equipped with a screen 104 for displaying the counted laps and the covered distance and control data and other interface data to the user. The distance meter 102 may also comprise one or more control buttons 106 for controlling the operation of the distance meter and for feeding data. In addition, the distance meter 102 can be equipped with fastening means, such as a suspender 108, for fastening the distance meter to the exercising person or to his/her garment.

In one example, during or optionally after the performance, the distance meter 102 of the invention can be in data transmission communication 110 with another data transmission device, such as e.g. a computer or a data processing device carried at the user's wrist. The data transmission connection 110 is most preferably carried out by means of a short-range radio link. In accordance with the invention, the distance meter 102 may be in data transmission communication with e.g. a wristwatch 112 collecting pulse data, allowing the fitness trainer to monitor the data collected by the distance meter directly on the screen of his watch, during the performance, for instance. Typically, the distance meter stores the data it has collected also in its memory means, allowing data to be checked later and perhaps transferred to some other data processing device, such as a computer, for instance. In an exemplified embodiment, the data of the distance meter and the means collecting pulse data can be monitored in combination, allowing e.g. the pulse to be observed as a function of the distance, the number of laps and/or time.

FIG. 2 shows a block diagram of an exemplified distance meter 102 to be worn by the user in accordance with the invention and also connections between any components of the distance meter. The components of the distance meter 102 are preferably interconnected by a mother board 202 or a similar connecting element. In one embodiment, the mother board may comprise a previously integrated unit performing e.g. arithmetic operations, such as a processor 204, a memory unit 206, a counter 207 and a clock 208. In addition, the distance meter typically comprises a power supply 210, preferably a battery.

A crucial component in the distance meter of the invention is a magnetic sensor 210 for measuring the direction of an external magnetic field, the sensor being carried out e.g. by means of a biaxial magnetic sensor of HMC1022 type. The magnetic sensor may also have several axes. The distance meter also has control means 214, preferably press buttons, for controlling the operation of the distance meter and for feeding data into the meter. The distance meter can also be equipped with a display unit 216, such as an LCD display for displaying data. The distance meter also typically comprises means 218 for data transmission, such as an IR transmitter, an IR transceiver or a short-range radio link. A short-range radio link can be carried out by means of Bluebooth techniques, for instance. Data transmission between a pulse meter carried at the wrist and the distance meter is most preferably carried out by means of a short-range radio link, however, data transmission e.g. between a computer and the distance meter can also be carried out with wire data transmission techniques.

In a preferred embodiment of the invention, the distance meter to be worn by the user may comprise also a controller 220. The controller may control the lap cycles relative to deviations in the measured magnetic field, relative to the time and relative to the length of a fed lap or side, and possibly to a fed sport type, and infer from this whether the deviation has occurred within the limits of normal conditions, or whether it is an erroneous interpretation, and then it either changes or does not change the value of the counter 207. The controller may also learn the fitness trainer's lap cycle by means of a special teaching mode, in which the fitness trainer programs the distance meter in teaching mode and performs the normal training performance around a track, the controller storing data relating especially to the turning points, and in one embodiment, the controller may even suggest a geometric pattern as the track. After the teaching mode, the controller may compare data of the consecutive laps with data of the lap performed during the teaching mode, such as deviations from the magnetic field as a function of time. In one embodiment, the controller may also change the sampling frequency to make it more consistent with the particular measuring situation.

The distance meter 102 of the invention may further comprise a sensor 222 detecting the fitness trainer's position, such as e.g. a sensor based on micro mechanic Bonded Silicon On Insulator (BSOI) techniques, or any other position-detecting sensor known by to those skilled in the art. The fitness trainer's position can be observed also by a magnetic sensor 212, especially a triaxial magnetic sensor. A position-detecting sensor 222, or optionally 212, may detect when the fitness trainer is in swimming position and when he/she is in vertical position, so that, in case of the swimming mode or of a distance meter especially intended for swimmers, erroneous lap counting due to vertical rotation at the pool end can be avoided. The sensor 22 or 212 may also detect whether the swimmer is swimming on his stomach or on his back. In one embodiment, the distance meter 102 may comprise also means 224 for identifying the operating mode of the meter, allowing detection of whether the meter is carried or not carried by the user. In one embodiment, the distance meter 102 may also comprise alarm means 226 for giving an alarm e.g. when a preset number of laps or distance is covered.

However, it should be noted that the distance meter 102 to be worn by the user in accordance with the invention is exemplified, and that at least part of the components are optional. In other words, the distance meter to be carried by the user in accordance with the invention can be implemented with a notably smaller number of components than those shown in FIG. 2.

FIG. 3 shows the operating situation 300 of an exemplified distance meter carried by the user in one embodiment of the invention, where the fitness trainer 101 is a swimmer swimming back and forth in a swimming pool 302. At a) the swimmer is swimming into a direction, where the south is on the rear left side and the north is on the front right side relative to the swimmer's direction of movement. The magnetic sensor included in the distance meter 102 to be carried by the user in accordance with the invention may thus infer the swimmer's direction of movement from the direction of the magnetic field 304 it has measured, in this case approx. 293°. At b), where the swimmer is returning in the same pool, the determined swimming direction is approx. 113°.

In the case of FIG. 3, the measurement is most definite and accurate, given the reversed signs of the measured components indicating the direction of the magnetic field at the turning point, where the swimmer resumes his incoming direction. Should the pool be positioned exactly in the north-south direction or in the east-west direction, the sign of only one of the measured components would be reversed, and this would yet be a sufficient indicator of the swimmer having turned back in the pool. In fact, the reversal detection is most straightforward when the sign of at least one of the measured components describing the direction of the magnetic field is reversed.

FIG. 4 shows the direction of a magnetic field measured by the distance meter of the invention as a function of time in the pool shown in FIG. 3, with the user swimming back and forth along a straight track. In the case shown in FIG. 3, the swimmer first swims along the track in a direction of about 290° for about 45 seconds, and then he resumes his incoming direction of 113°, and continues swimming for about 45 seconds. The cycle is extremely distinct and the measurement accuracy is good. Especially if the distance meter averages the values describing the direction of the magnetic field it has determined, any anomalies caused by slight meandering can be ignored. If the fitness trainer has fed the geometric pattern of the track and the length of the side or lap into the distance meter, the speed of said side or lap can be calculated after the side or lap has been counted. The average speed of longer intervals or optionally the fastest laps can also be determined.

However, it should be noted that, even if the sport shown in FIGS. 3 and 4 is swimming, the operation of the distance meter of the invention is by no means restricted to swimming alone, the meter being equally well applicable to other sports as well, such as e.g. cycling, skating, running or paddling, involving regular repeated movement along a track or lap.

FIG. 5 shows a square track and the direction of a magnetic field measured by the distance meter of the invention as a function of time, the fitness trainer equipped with the distance meter following a square track, whose sides 1) and 3) extend in the south to north direction. In the exemplified case of FIG. 5, the fitness trainer starts the performance at the intersection of sides 1) and 4), following first side 1) to the north (either 0° or 360°, in this case 0°) for about 28 seconds, and then turns to the west, into direction 270°, proceeding along side 2). Then the fitness trainer turns to the south on the track, into the direction 180°, following side 3), and finally towards starting point, i.e. towards the intersection between side 4) and side 1), proceeding along side 4) towards the east in the direction 90°. In this case as well, the characteristic of the direction of the magnetic field as a function of time is distinct, i.e. the characteristic clearly shows the turning points, allowing easy and accurate counting of the covered number of laps or sides.

FIG. 6 shows a triangular track and the direction of a magnetic field measured by the distance meter of the invention as a function of time, the fitness trainer equipped with the distance meter following the triangular track, where the fitness trainer starts from the intersection of sides 3) (east-west direction) and 1) and proceeds along side 1) towards the direction of about 330° for about 28 seconds, and then turns along side 2) to a direction of about 210° for about 28 seconds, and finally turns to proceed along side 3) into a direction of about 90° for about 28 seconds. It should be noted that having reached the starting point (intersection between sides 1) and 3)), the fitness trainer turns via the north to side 1), and then the characteristic describing the direction of the magnetic field may make a momentary stop at 0°, however, owing to the controller, this will be ignored in the counting of laps. The fact whether the characteristic describing the direction of the magnetic field stops at 0° depends among other things on the fitness trainer's turning speed and the sampling frequency of the distance meter of the invention.

In one embodiment of the invention, the sampling frequency of the distance meter can be changed. Especially on a long side or lap length, the sampling frequency can be set to a lower value, so that the direction of the magnetic field can be detected only every other second, for instance. The sampling frequency can be changed without requiring actions by the user.

In the case illustrated by FIG. 6 as well, where the fitness trainer follows a triangular track regularly, the characteristic of the direction of the magnetic field measured by the distance meter of the invention as a function of time is distinct, in other words, the characteristic distinctly shows the turning points, and hence the number of covered laps or sides can be readily and accurately counted.

FIG. 7 illustrates an oval track and the direction of a magnetic field measured by the distance meter of the invention as a function of time, the fitness trainer equipped with the distance meter following an oval track, where sides 1) and 3) are in the south-north direction and sides 2) and 4) in the east-west direction. In the exemplified case, the fitness trainer starts from point A, proceeding first in parallel with side 1) towards the north into an approx. 0° direction for about 20 seconds, and then he turns to proceed in parallel with side 2) into the direction of about 270° for about 30 seconds. As the fitness trainer has covered the stretch parallel with side 2), he/she further turns to proceed in parallel with side 3) to the south about 180° for about 20 seconds, and eventually, before one complete lap is covered, along side 4) to the east direction of about 90° for about 30 seconds.

It can be further noted that, when an oval track is regularly followed, the characteristic of the direction of the magnetic field measured by the distance meter of the invention as a function of time is distinct, i.e. the characteristic distinctly shows the turning points, and consequently, the covered number of laps or sides can be readily and accurately counted.

FIG. 8 illustrates an exemplified method 800 for implementing the operation of the distance meter carried by the user in one embodiment of the present invention, in which a magnetic sensor is initially fastened to a person with substantially stationary direction relative to the person. The operating mode of the distance meter can be identified in step 802 with the aid of a means for identifying the operating mode included in the distance meter, the value of the output signal of the means being determined by the operating mode of the distance meter, i.e. by the fact whether the distance meter is being or not carried by the user. In step 802a, the distance meter can be switched in standby mode (ON), provided that the distance meter is worn by the user, or in step 802b it can be switched off from the standby mode (OFF), provided that the distance meter has been taken off, on the basis of the output of the means for identifying the operating mode of the distance meter. However, steps 802, 802a and 802b are optional, and it should be noted that the standby mode could also be switched on with a switch such as an ON/OFF switch.

In the method of the invention, in step 804, track settings can be fed into the distance meter, such as e.g. the geometric pattern of the track to be followed (i.a. a straight, circular, triangular, square, rectangular, oval shape), the length of the lap and the length of the side. In step 804, a limit value for the deviation of the magnetic sensor relative to an external magnetic field can be fed, or optionally, the limit value can be inferred from the fed geometric track pattern. The operating mode of the distance meter can be fed in step 806, but this is not compulsory. The operating mode may describe e.g. the type of sport to be performed, and it may be e.g. a running mode, a skating mode or a swimming mode. In one embodiment, a swimming mode, for instance, can be identified without requiring the user's actions, with the aid of a sensor detecting the fitness trainer's position. The actual training area can be detected in step 808 as the direction of the magnetic field as a function of time at a specific sampling frequency. The sampling frequency may be fixed, or in one embodiment, it can be adjusted to the fed operating mode, the geometric track pattern and the length of the lap or the side, among other variables.

When there is a deviation of the direction of the measured magnetic field, step 810 can evaluate the reliability and permanence of the deviation and also conclude whether the deviation was due to the fitness trainer's turning to another side on the track, for instance, or whether the deviation was a sudden deviation caused by an evasive movement, for instance. If step 810 evaluated the deviation as an acceptable one, the value of the counter counting the number of laps or sides in increased in step 812. This step may also calculate the covered distance with the aid of the fed track data and the counted laps. In one embodiment, step 812 may deliver the number of counted laps and distance data over a data transmission communication to another data processing device, such as a device collecting pulse data, which the fitness trainer carries at his/her wrist. However, it should be noted that data can be transferred between an external data processing device and the distance meter carried by the user in accordance with the invention also during other steps, and that the external data processing device may also be some other means collecting pulse data, such as a computer, for instance.

After step 812 or optionally after step 810, the method proceeds to step 814 in order to decide whether the measurement should be continued. If the user interrupts the measurement, for instance, the collecting of measurement data can be ended in step 816, and the collected data can be filed in a file. If the measurement is continued, the process may return to step 806, for instance. In one embodiment, and especially in the case of a distance meter intended for the swimming mode or swimmers, the swimmer's position can be concluded in step 806, i.e. the fact whether the swimmer is in swimming position or in vertical position. If the swimmer is in swimming position, the measurement can be carried on normally, but if the swimmer has remained resting in vertical position at the end of the pool, the measurement will be carried on only when the swimmer has resumed his swimming position. The swimming position can be monitored also during the other steps.

Only a number of embodiments of the invention have been described above. The principle of the invention can naturally be varied within the scope of protection defined by the claims, regarding details of the embodiment and fields of application, for instance. In particular, it should be noted that the distance meter of the invention can be manufactured in a simplified version for a specific sport or track, such as a straight track for swimmers, and then it is not necessary to feed or set the type of sport or track in the operating situation, but the entire measurement can be carried out by activating the meter at the outset of the performance and by stopping the meter at the end of the performance.

It should be further noted that, depending on the embodiment, the data transmission between the distance meter of the invention and the data processing device may be bi-directional, allowing the operation of the distance meter to be controlled by means of said data processing device. The fitness trainer may feed data into the distance meter of the invention in the course of the performance by means of a data processing device, such as a pulse meter carried at the fitness trainer's wrist.

1. A method (800) for measuring the distance covered by a person, characterised in
fastening to the person (101) a magnetic sensor (212) with substantially stationary direction relative to the person,
monitoring (808) any deviation of the magnetic sensor relative to the magnetic field (304) external to the sensor, and
counting the times (812) the deviation of the magnetic sensor relative to the external magnetic field exceeds a set limit value.

2. A method as defined in claim 1, characterised in that, before the performance starts, at least on of the following data is fed into the distance meter (102) reading the output of the magnetic sensor: type of sport, length of one lap or one side, data about the geometric pattern of the track and set value for the deviation of the magnetic sensor relative to an external magnetic field.

3. A method as defined in claim 1, characterised in that the fitness trainer's position is also detected and a decision about continuing the measurement is made on the basis of the detected position and the fed type of sport.

4. A method as defined in claim 1, characterised in that the distance covered is determined by the counted times and the fed length of a lap or a side.

5. A method as defined in claim 1, characterised in that data are delivered from the distance meter (102) to at least one other data processing device (112).

6. A distance meter (102) for measuring the distance covered by an object, characterised in that the distance meter (102) is a wearable distance meter, and that it comprises a magnetic sensor (212) for determining the direction of the magnetic sensor (212) relative to a magnetic field (304) external to the sensor (102), and also a counter (207), and that the wearable distance meter (102) is arranged to decrease the value of the counter (207) when the deviation of the magnetic sensor (212) relative to an external magnetic field (304) exceeds the set limit value.

7. A distance meter as defined in claim 6, characterised in that the distance meter (102) comprises fastening means (108) for fastening the sensor with substantially stationary direction relative to the object and in that the fastening means is a press stud, a strap, a belt, a suspender (108) or a garment equipped with a pocket substantially adapted to the size and shape of the meter, such as a pair of trunks.

8. A distance meter as defined in claim 6, characterised in that the distance meter (102) comprises control means (214, 216), such as a press button and a display for feeding at least one of the following data into the distance meter: type of sport, length of one lap or side, information about the geometric pattern of the track and a set value for the deviation of the magnetic sensor relative to an external magnetic field.

9. A distance meter as defined in claim 6, characterised in that the distance meter (102) includes a sensor (222) for detecting the swimmer's swimming position and vertical position, respectively.

10. A distance meter as defined in claim 6, characterised in that the distance meter (102) comprises a controller (220), which is arranged to evaluate the consistency of the measured lap cycle with at least one of the following: fed type of sport, length of lap, length of side, geometric pattern of the track, deviation of the magnetic sensor from the limit value of an external magnetic field and spent time.

11. A distance meter as defined in claim 6, characterised in that the distance meter (102) is arranged in data transmission communication (110) with at least one other data processing device (112).

12. A distance meter as defined in claim 11, characterised in that the data processing device is a computer, a display screen or a device measuring pulse data (112).

13. A distance meter as defined in claim 6, characterised in that the distance meter (102) comprises a means (224) for detecting the operating mode of the wearable distance meter, the means allowing the conclusion whether the meter is being worn or not worn by the user.

14. A distance meter as defined in claim 6, characterised in that the distance meter (102) is arranged to give an alarm when a preset distance or number of laps is covered.
